(19) United States
(12) Patent Application Publication
(10) Pub. No.: US 2013/0344235 A1
(43) Pub. Date: Dec. 26, 2013

(54) AUTOCATALYTIC ELECTROLESS COPPER USING HYPOPHOSPHITE REDUCER

(71) Applicant: J.G. Systems Inc., Miami, FL (US)

(72) Inventor: John J. Grunwald, Tel-Aviv (IL)

(21) Appl. No.: 13/913,443

(22) Filed: Jun. 9, 2013

(30) Foreign Application Priority Data
Jun. 21, 2012 (IL) 220597

(51) Int. Cl. C09D 7/12; C23C 18/54

(52) U.S. Cl. CPC C09D 7/1216; C23C 18/54
USPC 427/99.5; 106/1.18; 106/1.19

(57) ABSTRACT

This invention discloses compositions and methods that afford sustainable deposition of electroless copper coatings, using aqueous hypophosphite compositions as opposed to formaldehyde (FA)

The invention thus obviates the use of nefarious FA, a suspected carcinogen, presently the predominant reducer for plating electroless copper.

The patent enables to plate “heavy” copper thicknesses currently unobtainable by the prior art teachings of electroless copper processes, that are based on hypophosphite reducers.

The process and compositions of this patent are especially attractive for horizontal plating machines, currently using (FA) compositios.

It is also beneficial for plating electroless copper on aluminum or zinc diecastings

The patent further envisions electroless plating of silver in a cyanide-free composition.

### BACKGROUND OF THE INVENTION

The invention fills a big industry need of eliminating the use of FA electroless compositions widely or almost exclusively practiced at this time, especially in shops producing printed circuit boards (PCBs) for the electronics industry.

Attempts by workers in the field to find a satisfactory replacement for the environmentally unfriendly (FA) reducer have been unsuccessful, and as a result FA is currently the only reducer that will autocatalytically reduce copper ions to metallic copper, and thus affords deposition of “thick” copper films, typically in the range of about one micron.

Teachings of instant invention will yield copper thicknesses of one micron or more, without however necessitating FA.

Further, this invention will allow operating temperatures significantly lower than prior art teachings of hypophosphite-reduced electroless copper baths, that call for bath temperatures approaching 90 degree C. Such elevated solution temperatures are especially unattractive for use in horizontally operated automatic PCB plating lines, because they impose a great burden on consruction materials of said horizontal machines

In spite of the undesirable features of FA, current automatic horizontal PCB plating machines have no choice but to use FA reducers, a considerable deterrent for widespread acceptance of said horizontal automatic machines.

As to electroless copper on Al and Zn , there are no known processes that enable plating electroless copper on said metals, because their contact with the high alkalkalinity of FA-base electroless copper compositions will result in severe surface attack. Yet, there is a strong need to plate electroless copper on Al, Zn for improved corrosion and tarnish protection afforded by Cu—P alloy coating obtained from hypophosphite-base electroless copper compositions.

In contrast to the prior art, this invention embodies the use of hypophosphite to replace FA in electroless copper installations, and yet enables depostion of “thick ” copper films at temperatures well below those proposed by the prior art baths that try to work with hypophosphite reducers.

Also, as mentioned earlier, the patent envisions deposition of electroless copper preferably, but not restrictedly, directly on substrates such as Al or Zn In the case of plating Al, the prior art necessitates treatments known as zincates, that are environmentally undesirable as they may involve solutions comprising cyanides. Plating copper directly on Al or Zn wherever possible as disclosed in this patent, potentially avoids intermediate surface treatments such as zincates.

### PRIOR ART

The prior art made numerous, though unsuccessful efforts, to find reducers other than FA, to reduce copper ions to metallic copper.

The need to eliminate FA, is driven by the following problem:

1. As mentioned earlier, FA is a suspected carcinogen.

2. FA-based compositions are unstable and prone to “bulk” decompositions, causing the bath to become prematurely useless, needing to be dumped. This, again, imposes a heavy burden on the environment.

3. Electroless FA compositions are costly, due to the known Cannizzaro reaction that wastefully consumes caustic and FA, even if the bath is not in use, and stands idly.

4. The high alkalinity of FA compositions makes them unsuitable for plating copper on aluminum, zinc diecastings, and polyimide, because of surface attack or corrosion.

U.S. Pat. Nos. 4,265,943, 4,209,331 and 4,279,948, co-invented by applicant, are referenced herewith in their entirety. They pioneered the idea of FA-free plating processes, by disclosing methods and compositions that use hypophosphite reducers instead of FA.

Above-referenced patents and other prior art electroless copper solutions, usually comprise one complexor, copper ions, and at times also ions of nickel, cobalt and other heavy metal ions.

Even though above-referenced patents propose combinations of complexors to embody hypophosphite-reduced electroless copper compositions, current hypophosphite formulations practiced in the industry, are typically formulated with a single complexor.

Also, while above referenced patents routinely mention compositions incorporating other ions in addition to copper, such as nickel, cobalt ions, etc., they still failed to significantly alleviate the short comings of such processes, namely high temeperature operation, low deposition rates resulting in impractical thicknesses of deposited copper films.

Indeed, in above-referenced processes, copper deposition essentially stops, when the Pd layer of the activated non-metallic substrate is covered with copper. This results in copper coatings too thin for further processing, such as imaging, electroplating, etc.

Hence, above-referenced patents, as well as other patents that followed in years thereafter, such as U.S. Pat. No. 6,046,107 to Lee at al, are not significantly practiced if at all, due to their inability to generate copper films sufficiently thick for satisfactory processing, of PCBs. As a result, FA is still the dominant reducer in the manufacture of through hole copper plated interconnect PCBs

Again, as mentioned before, hypophosphite reduction of copper ions to copper metal is not autocatalytic, resulting in deposition of only a few tenths of a micron or less, when deposited for example on glass epoxy, palladium-activated substrates.

### BRIEF DESCRIPTION OF THE INVENTION

Instant invention discloses mildly alkaline aqueous solutions, comprising multiple complexors, or at lest two. It has yet to be mechanisticaly understood why or how, multiple complexors boost the reduction of copper ions to metallic copper, via hypophosphite. It is thus understandable why the prior art failed to promote and emphasize the importance of multiple complexors for hypophosphite electroless copper baths.

Further while prior art references disclose compositios that comprise in addition to copper ions, nickel, cobalt or other ions, they failed to reduce to practce practicable processes and composititons that contain both copper and nickel ions, and alleviate difficulties of high operating temperature, poor plating rates, incomplete coverage etc inherent in hypophosphite-based electroless copper compositions.

Indeed, current hypophosphite formulations offered by suppliers, do not comprise nickel ions, to the best information of applicant.

It should be pointed out that copper ions are known to act as catalytic poisons in the reduction of nickel ions to nickel metal via hypophosphite, as underscored in U.S. Pat. No. 3,832,168 to Gulla. It is therefore understandable that the prior art failed to envision eletroless hypophosphite compositions comprising both nickel and copper ions, to plate electroless copper.

Summarizing the Main Objects of this Invention:

1. Allow deposition of copper films approaching one micron thicknesses or more;

2. Afford operating temperatures of about 70 to 75 degree C., as opposed to 80-90 deg. C proposed by the prior art employing hypophosphite reducers.

3. Employ compositions that rely on environmentally-friendly complexing chemicals.

4. Embody methods and compositions that afford copper coatings whose thickness is comparable to what can be achieved with FA, with said compositions operated at moderate temperatures , in the range of 60 to 80 deg. C.

5. Allow electroless copper deposition on Zn and Al castings preferably, but not restrictedly, without intermediate coatings or layers such as zincates.

This invention teaches that aqueous hypophosphite-based electroless compositions comprising multiple complexors, copper ions, and at times also nickel ions, operated at mildly alkaline pH, will surprisingly result in continuous, sustainable electroless copper plating, as opposed to prior hypophosphite formulations wherein the copper only deposits on exposed Pd.

In another embodiment of this invention, electroless copper compositions using hypophosphite reducer, will also comprise nickel ions for synergistic effects, as mentioned earlier.

Indeed, it has been unexpectedly discovered as disclosed earlier, that user-friendly hypophosphite-based electroless copper can be reduced to practice, by formulating solutions comprising multiple complexors or at lest two, optionally comprising nickel ions in addition to copper ions.

While the invention is focusing on compositions comprising copper and nickel ions, it is envisioned that other ions of Groups 9 and 10 Transition metals, can replace or complement nickel ions.

Also, the patent proposes embodiments involving electroless deposition of Transition Metals of Group 11 (Ag), in addition to electroless deposition of Cu.

Further, while the invention focuses mainly on electroless copper coatings that comprise only trace amounts of nickel, the teachings of the patent will enable one skilled in the art, to controle the ratrio of copper to nickel in the copper/nickel alloy, from one with predominantly copper, to one with predominantly nickel.

Additionally, while present invention focuses on mechanisms that allow electroless plating of copper, aided by the presence of nickeli ions in the composition, it also envisions electroless plating of other metals, especially silver, via the same, or similar mechanism, as mentioned above.

For example, the embodiment that will deposit electroless silver on a metal substrate in lieu of copper, envisions adding silver salts, preferably silver nitrate, to a composition similar to the ones described in the paragraph below, wherein capper will be completely or partially replaced by silver salts

### DETAILED DESCRIPTION OF THE INVENTION

The embodiment of this invention comprises the following solution components:

1 An aqueous, mildly alkaline solution operating at a pH of about 8 to 11;

2. A cupric salt , preferably cupric sulfate;

3 Optionally, a salt of nickel, preferably nickel sulfate;

4. At least two complexing agents one of which is monoehanolamine (MEA) to keep the cupric and nickel ions in solution;

5. A hypophosphite salt, preferably sodium hypophosphite.

When contacting an aluminum die casting, or a palladium-catalyzed non-metallic substrate, such as glass epoxy with a bath of above-described composition, operated at a temperature of 60 to 80 degree C., it will be coated with a lustrous deposit of a metallic copper layer, whose thickness can be in the range of 1 to 2 microns, or higher.

It is postulated without being bound by theory, that the copper metal obtained in practicing this invention is an alloy of Cu—P, or an alloy of Cu—Ni—P, wherein the copper plate will contain small/trace amounts of codeposited phosphorus, and optionally trace amounts of nickel, which is apparently the reason for its continuous, seemingly “autocatalytic” behavior. It is this Cu—P, or Cu—P—Ni alloy that presumably makes the electroless deposition of this invention self-sustaining, and affords copper thicknesses hitherto unobtainable with hypoposphite compositions of the prior art.

In the case where the substrate to be plated is a metal like Al casting, it is theorized that the Cu produced by hypophosphite reduction using compositions taught by this patent, is a Cu—P, or Cu—Ni—P alloy which is presumably autocatalytic and sustains the reduction reaction for the duration of the substrate's immersion in solution.

Another possible hypothesis that explains why/how Al substrates can sustain heavy depositions of electroles copper in hypophosphite-based compositions, implies some “nebulous” mechanism of the substarte's synergistic effect on the deposition process, perhaps as a result of some displacement deposition of copper, at least initially.

The term “autocatalytic” in this invention, denotes that reduction of copper ions to copper metal is “self-sustaining ”, possibly aided by nascent hydrogen evolving at the solid/solution interface, itself a powerful reducer.

Indeed, as noted earlier, it is an accepted theory that copper metal will not catalyze or trigger hypophosphite reduction, unlike nickel metal or palladium metal which are known to catalyze reduction of hypophosphite.

It was also surprisingly observed that properly catalyzed non-metallic substrates such as galss-epoxy, when contacted with a composition of this invention, will display vigorouse effervescence at the substrate/solution interface, again presumably caused by hydrgen evolution. It is speculated that such “nascent” hydrogen acts as “auxiliary” reducer that promotes copper ion reduction to copper metal in a sustained, seemingly “autocatalytic” fashion.

In the case of plating copper on aluminum castings, it is noted that a composition comprising hypophosphite, at least two complexors, copper ions and optinally also Ni ions, operated at a pH of about 9-10, a temperature of about 60 to 75 deg. C, will display effervescence at the Al/solution interface, shortly after the Al is immersed in the bath. It is again postulated that the effervescence is caused by hydrogen evolution, presumably nascent hydrogen, a powerful reducer.

In a preferred embodiment of this invention, the Al substrate or a palladium-catalyzed epoxy-glass substrate, will be stationary for about 10 to 60 seconds immediately after contacting the electroless copper solution, to allow copious hydrogen evolution. The substrate is then preferably agitated inside the solution, in the form of solution movement, work agitation, vibration, ultrasound etc., or combinations thereof.

No such vigorous effervescene was encountered or noted with hypophosphyte-based electroless copper composiotions of the prior art.

The selection of complexors can be made from a wide variety of metal-complexing chemicals offered by industries such as metal cleaning, electroplating, metal etching, stripping, etc. One skilled in the art will arrive at the optimal complexor combination by routine experimentation.

Furthermore, the ratio of complexor concentration to metal ion concentration will also be preferably optimized by trial and arror, as it was shown to have a major impact on plating rate, color and composition of deposited copper. It also minimizes or eliminates deposition of grey, nickel-like undesirable deposit, when the bath comprises Ni ions in addition to copper ions.

It is also essential to optimize the ratio of copper to nickel ion concenttration in solutions comprising both nickel and copper ions. Indeed, a “high” ratio of nickel to copper ion will yield a metal coating with a nickel-like appearance. Conversely, a “high” ratio of coppr to nickel ion in solution, will prevent plating all together.

In a preferred embodiment of this invention, complexors will be environmentally friendly and easy to dispose of. This invention will thus preferably exclude high concentrations of complexing chemicals such as EDTA, HEDTA and the like, extensively proposed by the prior art for hypophosphite-bearing electroless copper formulations.

Indeed, solutions comprising complexors such as EDTA are banned in many european countries because they form “tightly” complexed metal ion compositions, that make efluent treatment/recycling it purification into potable water sources, very problematic.

In one of many possible embodiments of this invention, complexors of choice will be aliphatic or aromatic hydroxy acids or their salts, aromatic or aliphatic amine, amides, or mixtures thereof.

A preferred embodiment of this invention, will employ a combination of aliphatic hydroxy acids and aliphtic amines, as will be shown in the examples that follow.

Again, at the risk of being redundant it is pointed out that the choice and especially the relative concentration of copper ions vs. nickel ions, will require careful balancing to favor Cu metal deposition as opposed to nickel. Indeed, deposition of electroless nickel may cause difficulties in further processing of printed circuits, such as copper electroplating, or copper etching.

The copper and nickel salts can be sulphates, chlorides, nitrates phosphates, etc., with sulfates being preferred.

In achieving and maintaining the desired alkaline pH range, one skilled in the art can resort to metal hydroxydes, amines, ammonia, carbontes, phosphates, etc. in most formulations of this invention, aliphatic amines are pereferred.

As to the operating temperature, it too has to be optimized as a function of the substate, when plating metal substrates such as Al, or non-metallics like epoxy/glass.

Also, it has been noted that the operating temperature of the hypophosphite-based composition, can presumably impact the color and composition of the deposited copper metal, ranging from the desired lustrous pink copper, to a grey deposit suggesting significant and undesirable nickel inclusion in the copper layer, when the composition comprises nickel ions.

It has also been surprisingly and unexplainedly noted that vigorous work agitation, following the initially recommended stationary immersion of the substrate in the electroless solutions of this invention comprising bothe nickel and copper ions, will significantly depress formation of a grey deposit, presumably containing nickel, in favor of a lustrous, pink copper color

Summarizing, the patent's focus is to achieve satisfactory/thick electroless copper plating of metals such as Al or Zn, or of interconnecting through holes of a PCB, using hypophosphite reduction. This is achieved by embodying compositions that will plate copper with a trace of P, or with a trace of both Ni and P, when nickel ions are present in solution, in addition to copper ions.

While a preferred embodiment of this invention teaches direct plating of electroless copper on Al or Zn without intermediately deposited layers, it also envisions plating the electroless copper following a conversion coating, for example phosphates, zincates, etc., deposited prior to electroless copper plating,

The pre-plating preparation of the metals such as Al, Zn, or epoxy/glass for electroless depostion, is abundantly described in the literature, and technical data sheets offered by vendors. It is also described in the patents referenced in the Prior Art section of this disclosure, in the case of printed circuit manufacture.

The patent will be further detailed in the examles that follow. Persons skilled in the art will find numerous other ways to implement the teaching of the patent.

### EXAMPLE 1

An aluminum diecasiting was clened and deoxidized following processes and solutions recommended by vendors It was then contacted with an aqueous solution heated to about 70 deg. C., said solution comprising the following:

Citric acid 40 g/l, rochelle salt 40 g/l, sodium chloride 20 g/l, monoethanolamine 110 ml/l, copper sulphate 10 g/l, and sodium hypophosphite 40 g/l.

Strong effervescence was observed at the substarte/solution inteface, and after about 10 min. immersion time, the Al was covered with a lustrous copper coating.

The Al part was then water rinsed and baked to ensure adhesion of the copper coating to the Al substrate.

### EXAMPLE 2

An aqueous solution was made up as follows:

Citric acid 40 g/l, NaCl 10 g/l, monoethanolamine 80 cc/l., NiSO4 6 g/l, CuSO4 4 g/l. sodium hypophosphite 40 g/l. The solution was heated to 70-75 deg. C

An epoxy-glass panel with through holes, cleaned and catalyzed for metalization using compositions and process steps practiced in the manufacture of PCBs printed circuit industy, as recommended by vendors. The panel was then contacted with above aqueous solution.

A strong effevescence was noted at the panel/solution interface. Following about 30 sec, immersion time, the panel was agitated in the bath, for about 10 minutes.

Inspection of the panel showed complete hole coverage, with a lustrous copper coating, estimated at 1.1 micron thickness.

### EXAMPLE 3

Same as Example 1, except that 40 g/l Rochell Salt was added to the solution described in EXAMPLE 1.

A panel as described in Example 1 was plated for about 10 minutes at 75 deg. C.

Inspection of the panel showed complete hole coverage with a lustrous, bright copper layer, estimated at 1.3 micron thickness.

It is pointed out that monoethanolamine (MEA) in above examples serves as secondary complexor, along with citric acid , and/or Rochelle salt , as well as pH adjustor. In all examples above, the pH was approximately 9.5.

1. An aqueos alkaline electroless copper composition comprising copper or silver ions, at least three complexing agents, and hypophosphite.

2. An aqoueous alkaline electroless copper plating composition comprising copper ions, nickel ions, at least two complexing agents, one of which is MEA and sodium hypophosphite.

3. An aqueous composition according to claim 1, comprising at least four complexing agents.

4. An aqueous composition according to claim 2, wherein copper ions are replaced by silver ions.

5. An aqoueos composition according to claim 1, wherein at least one com plexor is a hydroxy acid.

6. An aqueous composition according to claim 1, wherein at least one of the complexors is an amine.

7. An aqueous solution according to claim 1, wherein the complexing agents are aliphatic.

8. The method of depositing electroless copper or silver on a solid substrate by immersing said substrate in any one composition of claim 1.

9. The method of claim 8, wherein said substrate is kept stationary for at least 30 seconds following immersion in the coppper solution.

10. The method of plating electroless copper on a solid substrate according to claim 1, wherein plating is carried out in a horizontal conveyorized automatic plating machine.

11. The method of plating electroless copper on a solid substrate according to claim 2, wherein plating is carried out in a horizontal conveyorized automatic plating machine.

12. The method of plating electroless copper on a solid substrate according to claim 3, wherein plating is carried out in a horizontal conveyorized automatic plating machine 11.

13. The method of plating electroless copper on a solid substrate according to claim 4, wherein plating is carried out in a horizontal conveyorized automatic plating machine.

14. The method of plating electroless copper on a solid substrate according to claim 5, wherein plating is carried out in a horizontal conveyorized automatic plating machine.

15. The method of plating electroless copper on a solid substrate according to claim 6, wherein plating is carried out in a horizontal conveyorized automatic plating machine.

16. The method of claim 10, wherein the substrate is a PCB.

17. A PCB produced according to claim 8.

18. An Al or Zn diecasting plated with electroless copper using methods of claim 7.

19. The product of claim 17, wherein the copper plate is an alloy of Cu—P or Cu—Ni—P.

20. The product of claim 18, wherein the copper plate is an alloy of Cu—P or Cu—Ni—P.

21. The product according to claim 17 wherein the copper in the alloy is at least 90%.

22. A solid substrate plated with electroless silver using the composition in accordance with claim 4.
